(19) United States
(12) Patent Application Publication
(10) Pub. No.: US 2021/0218170 A1
(43) Pub. Date: Jul. 15, 2021

(54) ELECTRIC CONNECTOR

(71) Applicant: SAKAI DISPLAY PRODUCTS CORPORATION, 1, Takumicho, Sakai-ku (JP)

(72) Inventor: KOHJI NAGASAKA, Sakai-shi, Osaka (JP)

(21) Appl. No.: 17/058,326

(22) PCT Filed: May 30, 2018
(86) PCT No.: PCT/JP2018/020823

§ 371 Date: Nov. 24, 2020

(51) Int. Cl. H01R 12/77; H01R 12/79; H01R 12/88; H01R 12/70

(52) U.S. Cl. CPC H01R 12/774; H01R 12/7005; H01R 12/88; H01R 12/79

(57) ABSTRACT

An electric connector (100) is provided with a housing (110), an actuator (120), and a signal terminal (130). A signal transmission member is connected to the electric connector (100). The actuator (120) is mounted to the housing (110). The signal terminal (130) is provided to the housing (110) and is electrically connected to wiring of the signal transmission member. The actuator (20) comes into contact with the signal terminal (130) when the actuator (120) is moved from a first position where the signal transmission member is affixed while the wiring of the signal transmission member is connected to the signal terminal, to a predetermined second position where the signal transmission member is released from the affixation.

### TECHNICAL FIELD

The present invention relates to an electric connector.

### BACKGROUND ART

Electric connectors are used in various electronic devices as means for coupling signal transmission media such as a flexible flat cable and a flexible printed circuit board. For example, it is known that a signal transmission medium is coupled to an electric connector by pressing the signal transmission medium using an actuator of the electric connector through the actuator turning with a connector member of the electric connector electrically connected to the signal transmission medium (see Patent Literature 1).

### CITATION LIST

### Patent Literature

[Patent Literature 1] Japanese Patent Application Laid-Open Publication No. 2016-129124

### SUMMARY OF INVENTION

### Technical Problem

However, in the electric connector in Patent Literature 1, when the signal transmission medium is charged, a fault due to electrostatic discharge (ESD) may occur in the electric connector and a circuit electrically connected to the contact member of the electric connector in insertion of the signal transmission medium into the electric connector.

In view of the forgoing, the present invention has its object of providing an electric connector that inhibits occurrence of a fault due to electrostatic discharge.

### Solution to Problem

An electric connector according to the present invention includes a housing, an actuator, and a signal terminal. A signal transmission member is to be coupled to the electrical connector. The actuator is mounted on the housing. The signal terminal is provided on the housing and electrically connected to a wire of the signal transmission member. When the actuator moves from a first position to a specific second position, the actuator comes in contact with the signal terminal, the first position being a position where the signal transmission member is fixed with the wire of the signal transmission member connected to the signal terminal, the second position being a position where fixation of the signal transmission member is released.

### Advantageous Effects of Invention

According to the present invention, occurrence of a fault due to electrostatic discharge can be inhibited.

### BRIEF DESCRIPTION OF DRAWINGS

FIG. 1 is a schematic perspective view of an electric connector according to a first embodiment.

FIG. 2A is a schematic perspective view of the electric connector according to the first embodiment when an actuator is positioned at a first position, and FIG. 2B is a schematic perspective view of the electric connector according to the first embodiment when the actuator is positioned at a second position.

FIGS. 3A and 3B are schematic perspective views describing assemblage of the electric connector according to the first embodiment.

FIGS. 4A to 4C are schematic perspective views explaining a process of coupling a signal transmission member to the electric connector according to the first embodiment.

FIG. 5 is a schematic perspective view of a substrate on which the electric connector according to the first embodiment is mounted.

FIG. 6 is a schematic perspective view of an electric connector according to a second embodiment.

FIG. 7A is a perspective view of an electric connector according to a third embodiment, and FIG. 7B is side view of the electric connector according to the third embodiment.

FIG. 8 is a schematic perspective view of a substrate on which the electric connector according to the third embodiment is mounted.

FIG. 9 is a schematic perspective view of an electric connector according to a fourth embodiment.

FIGS. 10A to 10C are schematic perspective views explaining a process of coupling a signal transmission member to the electric connector according to the fourth embodiment.

### DESCRIPTION OF EMBODIMENTS

The following describes embodiments of an electric connector according to the present invention with reference to the accompanying drawings. However, the present invention is not limited to the following embodiments. Note that an X direction, a Y direction, and a Z direction that are perpendicular to one another are indicated in the present description to facilitate understanding of the invention. The X direction and the Y direction are parallel to a horizontal plane, while the Z direction is parallel to a vertical direction.

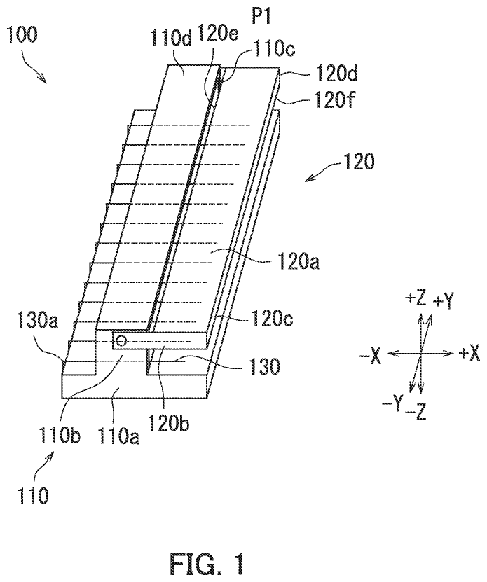

An electric connector 100 according to a first embodiment of the present invention will he described with reference to FIG. 1. FIG. 1 is a schematic perspective view of the electric connector 100 according to the first embodiment. The electric connector 100 is electrically connected to a signal transmission member to he coupled to the signal transmission member. Here, the electric connector 100 is placed on a plane expanding in the X direction and the Y direction and a longitudinal direction of the electric connector 100 is parallel to the Y direction.

The electric connector 100 includes a housing 110, an actuator 120, and signal terminals 130. Typically, the housing 110 is formed from an insulating member.

The actuator 120 is mounted on the housing 110. The actuator 120 moves relative to the housing 110. The actuator 120 is movable from a first position to a second position. Also, the actuator 120 is movable from the second position to the first position. Note that the actuator 120 is positioned at a first position P1 in FIG. 1. In a state in which the actuator 120 is positioned at the first position, the actuator 120 is electrically insulated from the signal terminals 130.

The actuator 120 moves relative to the housing 110 within a range in a specific direction. For example, the actuator 120 moves in a pivoting direction relative to the housing 110. Alternatively, the actuator 120 moves in a linear direction relative to the housing 110. For example, the first position is located at one end of a movable range of the actuator 120 in the specific direction while the second position is located at the other end of the movable range of the actuator 120 in the specific direction.

When moving from the first position to the second position, the actuator 120 comes in contact with the signal terminals 130. The actuator 120 has a contact surface at least part of which is in contact with the signal terminals 130 when the actuator 120 is in the second position.

The actuator 120 is thin and rectangular parallelepiped in shape. In FIG. 1, a length (thickness) of the actuator 120 in the Z direction is shorter than a length of the actuator 120 in the X direction and a length thereof in the Y direction.

The actuator 120 has an upper surface 120a, a side surface 120b, a side surface 120c, a side surface 120d, a side surface 120e, and a bottom surface 120f. Typically, it is preferable for at least part of the actuator 120 to be conductive. For example, it is preferable that the upper surface 120a of the actuator 120 be conductive. Furthermore, the upper surface 120a of the actuator 120 is preferably maintained at a ground potential. However, no part of the actuator 120 may be maintained at the ground potential.

The signal terminals 130 are provided on the housing 110. Typically, the signal terminals 130 corresponding to respective wires of the signal transmission member are provided on the housing 110. The signal terminals 130 are provided on a terminal placement surface of the housing 110. The signal terminals 130 extend in the X direction on an upper surface of the housing 110. The signal terminals 130 further extend in a negative Z direction from an end of the housing 110 in a negative X direction.

The housing 110 includes a base body 110a, a first side portion 110b, a second side portion 110c, and an upper portion 110d. The base body 110a is flat shaped. The base body 110a has an upper surface that serves as the terminal placement surface. The signal terminals 130 are provided on the base body 110a of the housing 110. The signal terminals 130 extend in the X direction on the upper surface of the base body 110a. Here, the signal terminals 130 each extend up to an end 130a thereof in the negative X direction on the upper surface of the base body 110a and each extend along a side surface of the base body 110a from the end 130a.

The first side portion 110b extends upward from the upper surface of the base body 110a. on a side of the base body 110a in a negative Y direction. The second side portion 110c extends upward from the upper surface of the base body 110a on a side of the base body 110a in a positive Y direction.

The upper portion 110d is located above the base body 110a and connects the first side portion 110b to the second side portion 110c. A space is formed between the base body 110a and the upper portion 110d.

The signal transmission member is inserted in the electric connector 100 to be coupled to the electric connector 100. Typically, the signal transmission member is coupled to the electric connector 100 as a result of movement of the actuator 120. The wires of the signal transmission member are electrically connected to the signal terminals 130 of the electric connector 100. The signal transmission member includes a flexible flat cable (FFC) or a flexible printed circuit (FPC) board. For example, almost all parts of each wire of the signal transmission member are covered with an insulating layer and only a terminal portion located at a distal end of each wire is exposed through the insulating layer.

In addition to the signal terminals 130, a ground terminal may be provided on the housing 110 of the electric connector 100. For example, the ground terminal may be formed of the same material as the signal terminals 130.

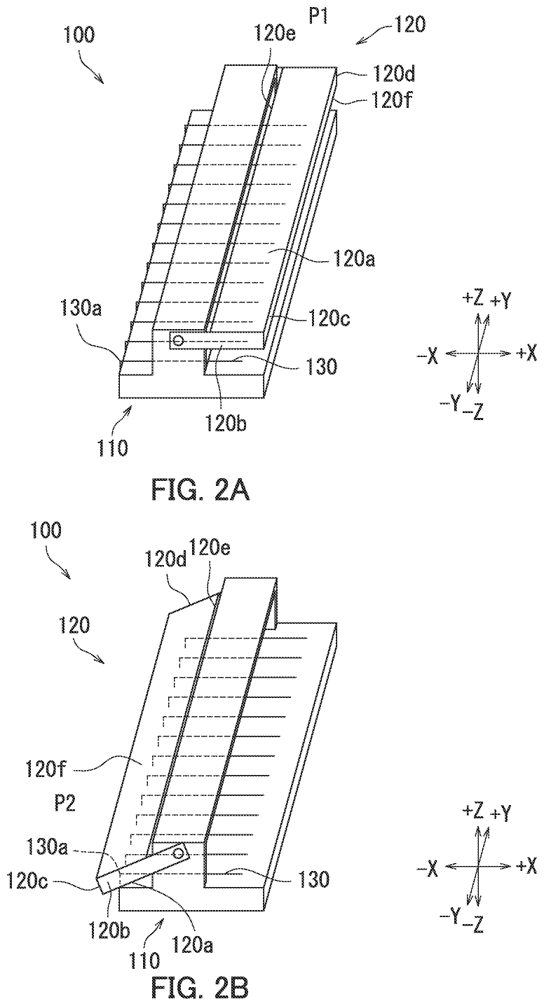

Positional change of the actuator 120 in the electric connector 100 according to the first embodiment will be described next with reference to FIGS. 2A and 2B. FIG. 2A is a schematic perspective view of the electric connector 100 in a state in which the actuator 120 is positioned at the first position P1. FIG. 2B is a schematic perspective view of the electric connector 100 in a state in which the actuator 120 is positioned at a second position P2.

As illustrated in FIG. 2A, when the actuator 120 is positioned at the first position P1, the bottom surface 120f of the actuator 120 faces the housing 110. However, the bottom surface 120f of the actuator 120 is out of contact with the signal terminals 130 on the housing 110. The bottom surface 120f of the actuator 120 faces the terminal placement surface of the housing 110. The housing 110 is separate from the actuator 120, and a specific space is formed between the housing 110 and the actuator 120.

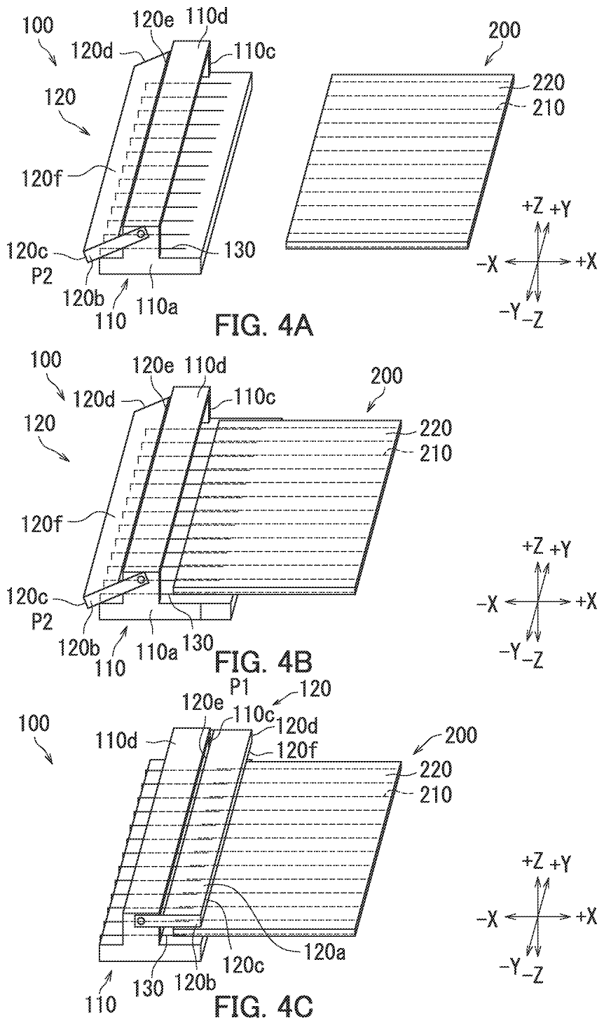

When positioned at the first position P1, the actuator 120 is located on a side relative to the upper portion 110d of the housing 110 in a positive X direction. As will be described later with reference to FIG. 4A to 4C, the signal transmission member is fixed to the electric connector 100 when the actuator 120 is positioned at the first position P1. Here, the signal transmission member is fixed in a space between the housing 110 and the actuator 120. When the signal transmission member is fixed therein, the wires of the signal transmission member are electrically connected to the signal terminals 130.

Here, the actuator 120 is mounted on the housing 110 in a pivotable manner. The actuator 120 is pivotable about an axis of rotation as a center thereof located in the housing 110. A pivotable range of the actuator 120 herein is 200 degrees or larger and 270 degrees or smaller.

For example, when the actuator 120 positioned at the first position P1 pivots anticlockwise relative to the housing 110, the actuator 120 moves from the first position P1 to the second position P2.

When positioned at the second position P2 as illustrated in FIG. 2B, the actuator 120 is in contact with the signal terminals 130. When positioned at the second position P2, the actuator 120 is located on a side relative to the upper portion 110d of the housing 110 in the negative X direction. When the actuator 120 moves from the first position P1 to the second position P2, the signal transmission member is released from fixation.

Here, the upper surface 120a of the actuator 120 positioned at the second position P2 is in contact with the signal terminals 130. The upper surface 120a of the actuator 120 accordingly serves as the contact surface in contact with the signal terminals 130. For example, the actuator 120 positioned at the second position P2 is in contact with the ends 130a of the signal terminals 130.

As illustrated in FIG. 2A, the upper surface 120a of the actuator 120 positioned at the first position P1 is away from the signal terminals 130. By contrast, as illustrated in FIG. 2B, when the actuator 120 moves from the first position P1 to the second position P2, the upper surface 120a, which serves as the contact surface, of the actuator 120 comes in contact with the signal terminals 130.

Preferably, the actuator 120 is maintained at the ground potential. In this case, even if the signal terminals 130 are charged, charge of the signal terminals 130 can be dispersed as a result of the actuator 120 at the second position P2 being in contact with the signal terminals 130. For this reason, occurrence of a fault due to electrostatic discharge can be inhibited.

However, the actuator 120 ray not be maintained at the ground potential. Even in this case, charge of the signal transmission member inserted in the electric connector 100 can be dispersed as a result of the actuator 120 at the second position P2 being in contact with the signal terminals 130. For this reason, occurrence of a fault due to electrostatic discharge can be inhibited.

Note that when the actuator 120 positioned at the second position P2 pivots clockwise relative to the housing 110, the actuator 120 can move from the second position P2 to the first position P1. The electric connector 100 can be fabricated by mounting the actuator 120 onto the housing 110.

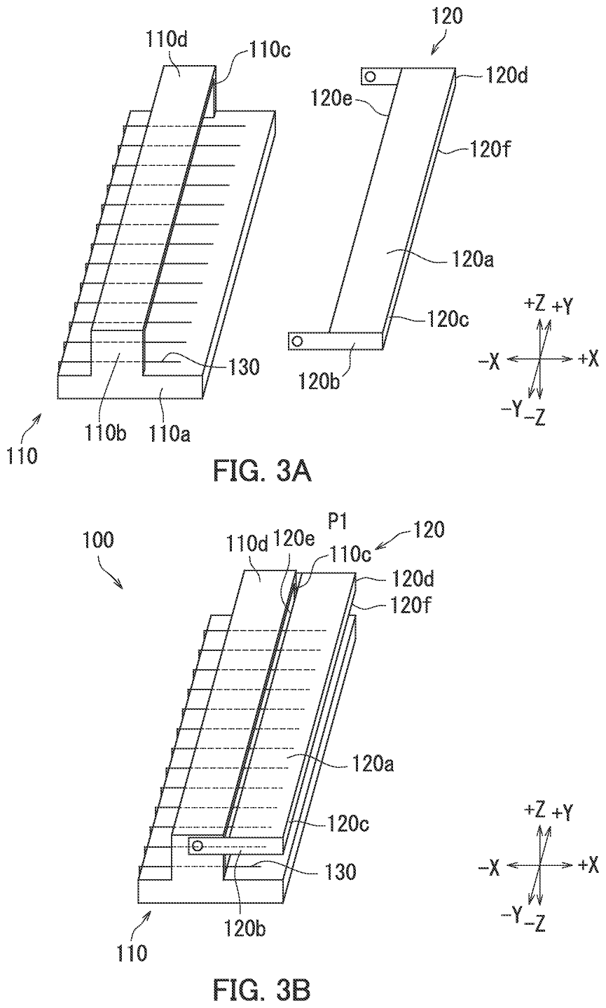

The following describes assemblage of the electric connector 100 according to the first embodiment with reference to FIGS. 3A and 3B. FIGS. 3A and 3B are schematic perspective views describing assemblage of the electric connector 100.

As illustrated in FIG. 3A, the housing 110 is prepared. Furthermore, the actuator 120 is prepared separately from the housing 110.

The housing 110 includes a base body 110a, a first side portion 110b, a second side portion 110c, and an upper portion 110d. The base body 110a. extends in the Y direction. A length of the base body 110a in the Y direction is longer than a length of the base body 110a in the X direction.

The first side portion 110b extends in a positive Z direction from an end of an upper surface of the base body 110a on a side of the base body 110a in the negative Y direction. The second side portion 110c extends in the positive Z direction from an end of the upper surface of the base body 110a on a side of the base body 110a in the positive Y direction.

The upper portion 110d connects the first side portion 110b to the second side portion 110c. The upper portion 110d extends in the Y direction similarly to the base body 110a. The upper portion 110d is located above the base body 110a, and a space is formed between the base body 110a and the upper portion 110d.

The signal terminals 130 are provided on the base body 110a of the housing 110. The signal terminals 130 extend in the X direction on the base body 110a. The signal terminals 130 are folded at the respective ends 130a in the negative X direction and further extend in the negative Z direction. Note that a length in the Z direction of a portion of each signal terminal 130 that extends in the negative Z direction is almost equal to a length of the base body 110a in the Z direction. It is possible that the signal terminals 130 are additionally folded at the respective ends in the negative Z direction and extend in the negative X direction.

The actuator 120 includes an upper surface 120a, a side surface 120b, a side surface 120c, a side surface 120d, a side surface 120e, and a bottom surface 120f. A mounting portion of the actuator 120 extends in the negative X direction from the side surface 120b. Also, a mounting portion of the actuator 120 extends in the negative X direction from the side surface 120d. The upper surface 120a of the actuator 120 is formed from a conductive member, for example.

As illustrated in FIG. 3B, the actuator 120 is mounted on the housing 110. Here, the actuator 120 is mounted at the first side portion 110b and the second side portion 110c of the housing 110. The axis of rotation of the actuator 120 passes through the first side portion 110b and the second side portion 110c of the housing 110. When the actuator 120 pivots relative to the housing 110, the actuator 120 pivots about the axis of rotation as a center.

For example, the first side portion 110b and the second side portion 110c of the housing 110 each has a screw hole formed therein. The actuator 120 may be mounted at the first side portion 110b and the second side portion 110c of the housing 110 by means of screws.

Alternatively, it is possible for a through hole to be formed in each of the first side portion 110b and the second side portion 110c of the housing 110 and for through holes also to be formed in the mounting portions of the actuator 120 in a manner corresponding to the through holes of the first side portion 110b and the second side portion 110c. In the above configuration, the actuator 120 may be mounted on the housing 110 by means of nuts and bolts that each penetrate a corresponding one of the through holes in the first side portion 110b and the second side portion 110c and a corresponding one of the through holes at opposite ends of the actuator 120.

Alternatively, it is possible that a recess or a through hole is formed in each of the first side portion 110b and the second side portion 110c of the housing 110 and that the actuator 120 includes protrusions that fit in the respective recesses or the respective thought holes of the first side portion 110b and the second side portion 110c of the housing 110. As described with reference to FIGS. 3A and 3B, the electric connector 100 can be constituted by the actuator 120 and the housing 110 on which the signal terminals 130 are provided.

The electric connector 100 according to the first embodiment is used favorably for electrical connection with the signal transmission member. For example, when the signal transmission member is inserted into the electric connector 100, the electric connector 100 is coupled to the signal transmission member with the signal terminals 130 of the electric connector 100 electrically connected to the wires of the signal transmission member.

The following describes a process of coupling a signal transmission member 200 to the electric connector 100 with reference to FIGS. 4A to 4C. FIGS. 4A to 4C are schematic perspective views describing the process of coupling the signal transmission member 200 to the electric connector 100 according to the first embodiment.

As illustrated in FIG. 4A, the electric connector 100 is prepared. Here, the actuator 120 of the electric connector 100 is positioned at the second position P2.

The signal transmission member 200 is also prepared separately from the electric connector 100. For example, the signal transmission member 200 is a flexible flat cable or a flexible printed circuit board.

The signal transmission member 200 includes wires 210 and a holding section 220. The wires 210 transmit electric signals. The holding section 220 holds the wires 210. The holding section 220 is formed from an insulating member.

As illustrated in FIG. 4B, the signal transmission member 200 is inserted into the electric connector 100. Once the signal transmission member 200 is inserted into the electric connector 100, the wires 210 of the signal transmission member 200 are electrically connected to the respective signal terminals 130 of the electric connector 100. At this time, the actuator 120 is preferably positioned at the second position P2. Even if the signal transmission member 200 is charged, charge of the signal transmission member 200 can be dispersed as a result of the actuator 120 at the second position P2. being in contact with the signal terminals 130, thereby achieving inhibition of occurrence of a fault due to electrostatic discharge.

As illustrated in FIG. 4C, the actuator 120 moves from the second position P2 to the first position P1. As a result of movement of the actuator 120, the signal transmission member 200 is fixed to the electric connector 100. Once the signal transmission member 200 is fixed, the wires 210 of the signal transmission member 200 remain electrically connected to the signal terminals 130 of the electric connector 100.

Note that when the actuator 120 is positioned at the first position P1, the actuator 120 may be in contact with the signal transmission member 200. In this case, the bottom surface 120f of the actuator 120 is in contact with the signal transmission member 200.

However, even in a configuration in which the actuator 120 is in contact with the signal transmission member 200, the wires 210 of the signal transmission member 200 are insulated from the actuator 120. Only in a configuration in which the actuator 120 is in contact with the signal transmission member 200, is it required that a contact area of at least one of the actuator 120 and the signal transmission member 200 be formed from an insulating material. For example, it is possible for the bottom surface 120f of the actuator 120 to be formed of an insulating material and to be in contact with the signal transmission member 200. Alternatively, it is possible for the wires 210 of the signal transmission member 200 to be covered with an insulating holding member 220 of the signal transmission member 200 and the holding member 220 to be in contact with the bottom surface 120f of the actuator 120.

Alternatively, the actuator 120 may be coupled to the signal transmission member 200 by means of another member without direct contact with the signal transmission member 200.

As described with reference to FIGS. 4A to 4C, the electric connector 100 can be coupled to the signal transmission member 200 in a state of being electrically connected to the wires 210 of the signal transmission member 200. The electric connector 100 according to the first embodiment can be used favorably in various electronic devices. For example, the electric connector 100 is used to electrically connect electronic components in a display device.

For example, the electric connector 100 is disposed on a substrate on which wires are provided. In one example, the electric connector 100 is disposed on a printed wire board (PWB) on which wires are printed.

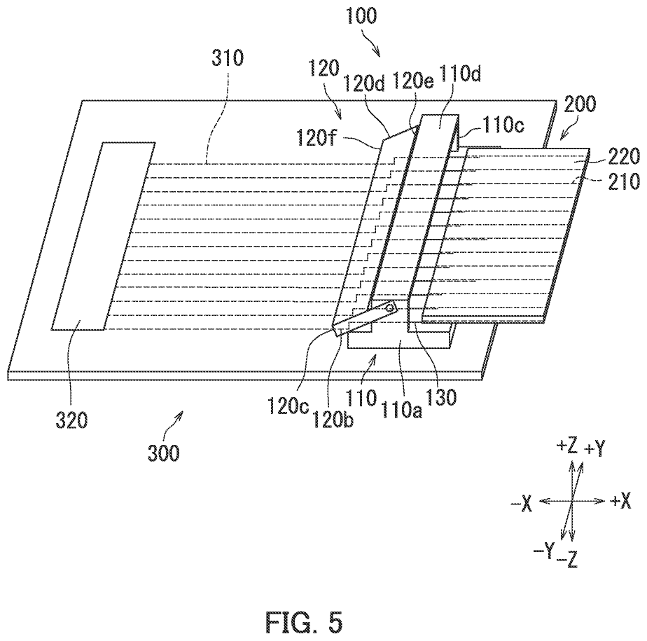

The following describes mounting of the electric connector 100 according to the first embodiment with reference to FIG. 5. FIG. 5 is a schematic perspective view of a substrate 300 on which the electric connector 100 according to the first embodiment is mounted. For example, the electric connector 100 is mounted on the substrate 300. In one example, the electric connector 100 is mounted on the substrate 300 by soldering.

A plurality of wires 310 are provided on the substrate 300. Here, the wires 310 are provided to extend in the X direction. As illustrated in FIG. 5, the wires 310 are electrically connected to ends of the signal terminals 130 each located on one side (a side in the negative X direction herein) of a corresponding one of the signal terminals 130.

Furthermore, an integrated circuit (IC) 320 is mounted on the substrate 300. Here, the wires 310 are electrically connected to the IC 320. Note that a conductive member set at the ground potential may be provided on the substrate 300 separately from the wires 310.

When the signal transmission member 200 is coupled to the electric connector 100, ends of the signal terminals 130 of the electric connector 100 each located on the other side (side thereof in the positive X direction herein) of a corresponding one of the signal terminals 130 are connected to the wires 210 of the signal transmission member 200. Accordingly, the wires 310 on the substrate 300 and the wires 210 of the signal transmission member 200 are electrically connected to each other through the electric connector 100.

Note that at least part of the actuator 120 preferably includes a conductive member as described above.

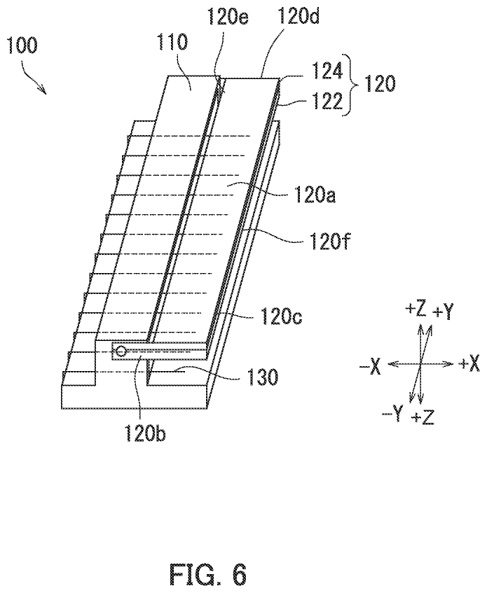

The following describes an electric connector 100 according to a second embodiment with reference to FIG. 6. FIG. 6 is a schematic perspective view of the electric connector 100 according to the second embodiment.

An actuator 120 of the electric connector 100 includes an insulating part 122 and a conductive part 124. The actuator 120 is formed by stacking the conductive part 124 on the insulating part 127.

For example, the insulating part 122 has an electrical conductivity of no greater than 10⁻⁶ S/m. Note that the insulating part 122 is preferably formed from a genera material having an electrical conductivity of at least 10⁻¹⁸ S/m.

For example, the conductive part 124 has an electrical conductivity of at least 10⁶ S/m. Note that the conductive part 124 is preferably formed from a general material having an electrical conductivity of no greater than 10⁸ S/m.

When the actuator 120 is positioned at the first position P1, the insulating part 122 is located on a side relative to the conductive part 124 in the positive Z direction. In the above configuration, an upper surface 120a of the actuator 120 exhibits conductivity while a bottom surface 120f of the actuator 120 exhibits an insulating property.

Preferably, the conductive part 124 of the actuator 120 is maintained at the ground potential. For example, the conductive part 124 of the actuator 120 may be electrically connected to a ground electrode.

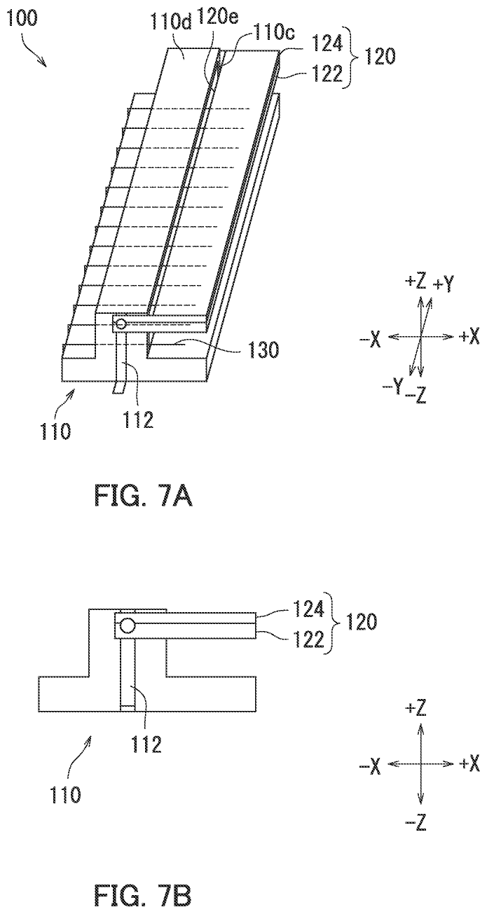

The following describes an electric connector 100 according to a third embodiment with reference to FIGS. 7A and 7B. FIG. 7A is a schematic perspective view of the electric connector 100 according to the third embodiment, and FIG. 7B is a schematic side view of the electric connector 100. The electric connector 100 illustrated in FIGS. 7A and 7B has a configuration similar to that of the electric connector 100 illustrated in FIG. 6 except that a conductive member 112 is disposed on an outer side of a housing 110. As such, duplicate description is omitted for the purpose of avoiding redundant description.

As illustrated in FIGS. 7A and 7B, the conductive member 112 is disposed on the outer side the housing 110. The conductive member 112 is electrically connected to an actuator 120. The conductive member 112 may be disposed in contact with the housing 110. The conductive member 112 may for example be attached to the housing 110. Alternatively, the conductive member 112 may be disposed out of contact with the housing 110.

Here, the actuator 120 is mounted at a first side portion 110b and a second side portion 110c of the housing 110. The conductive member 112 extends in the Z direction to a location where the actuator 120 is mounted from a surface where the electric connector 100 is placed. By contrast, an end of the conductive member 112 in the negative Z direction is folded to extend in the negative Y direction.

In the above configuration, the conductive member 112 is electrically connected to a conductive part 124 of the actuator 120. Accordingly, when the conductive member 112 is connected to a ground electrode, the conductive part 124 of the actuator 120 can be maintained at the ground potential. Preferably, the conductive member 112 is electrically connected to a ground electrode on a substrate, for example.

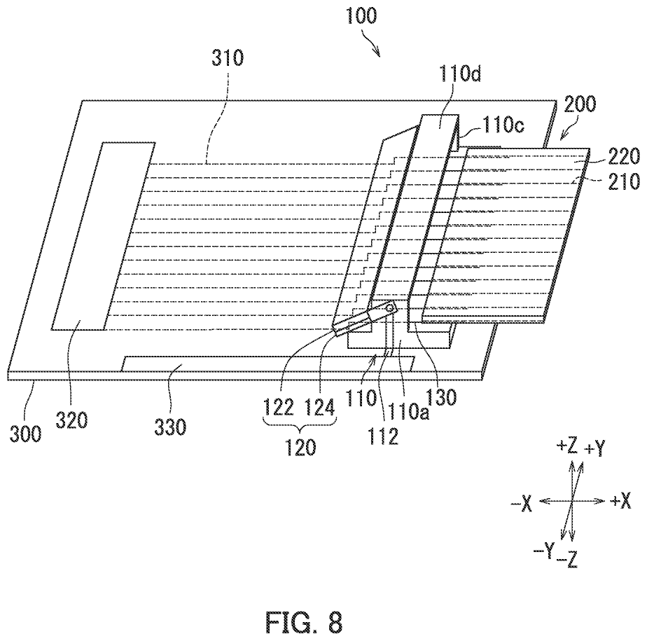

The following describes the electric connector 100 according to the third embodiment with reference to FIG. 8. FIG. 8 is a schematic perspective view of a substrate 300 on which the electric connector 100 according to the third embodiment is mounted. The electric connector 100 is mounted on the substrate 300. Note that the substrate 300 illustrated in FIG. 8 has a configuration similar to that of the substrate illustrated in FIG. 5 except that: a ground electrode 330 is provided on the substrate 300; the actuator 120 of the mounted electric connector 100 has an upper surface 120a that exhibits conductivity; and the conductive member 112 is provided on an outer side of the housing 110. As such, duplicate description is omitted for the purpose of avoiding redundant description.

The ground electrode 330 is disposed on the substrate 300 together with a plurality of wires 310 and an IC 320. The ground electrode 330 is set at the ground potential. Here, the ground electrode 330 is located on a side of the electric connector 100 in the negative Y direction and extends in the X direction.

The conductive member 112 is in contact with the ground electrode 330. The upper surface 120a of the actuator 120 is accordingly maintained at the ground potential through the conductive member 112. In this case, signal terminals 130 can be grounded as a result of the actuator 120 at the second position P2 being in contact with the signal terminals 130. Thus, occurrence of a fault due to electrostatic discharge can be inhibited even when a signal transmission member inserted in the electric connector 100 is charged.

Note that the housing 110 is preferably provided with a ground terminal in addition to the signal terminals 130 as described above. In this case, the upper surface 120a of the actuator 120 may not be maintained at the ground potential.

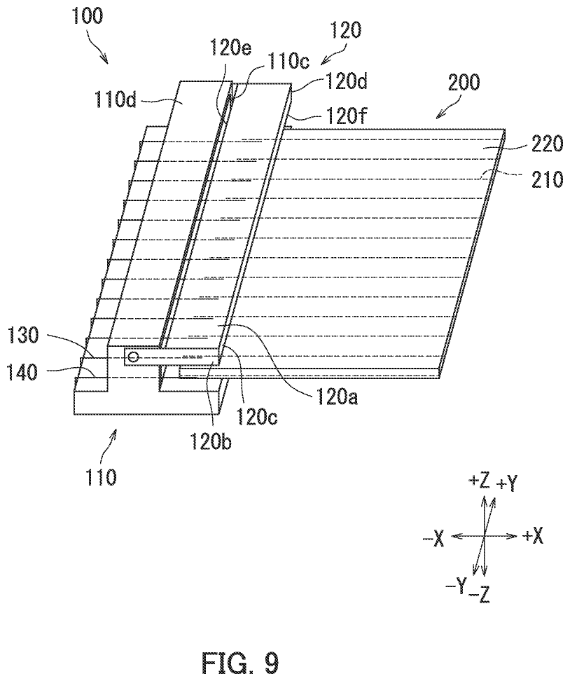

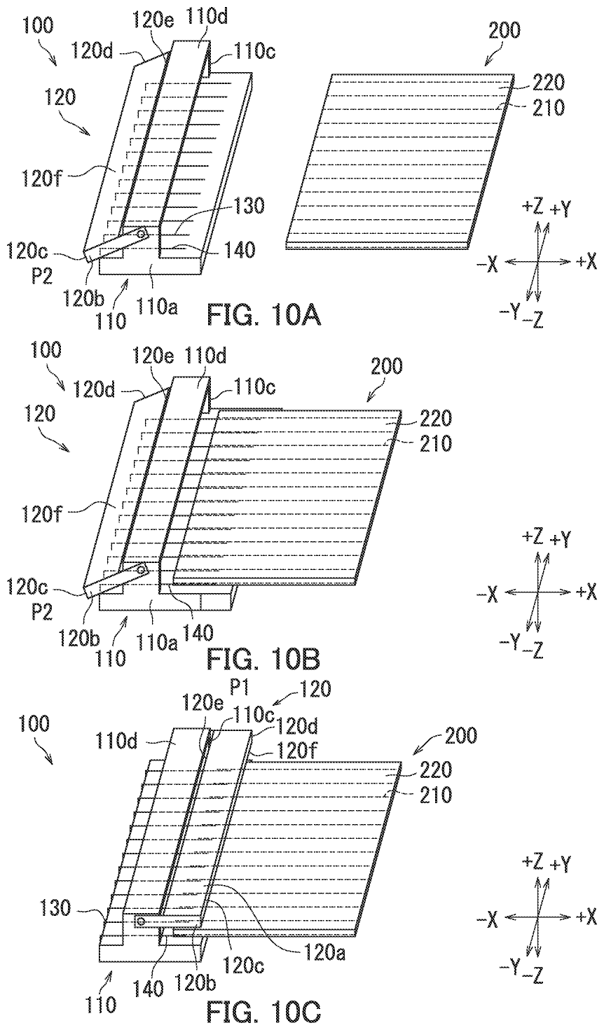

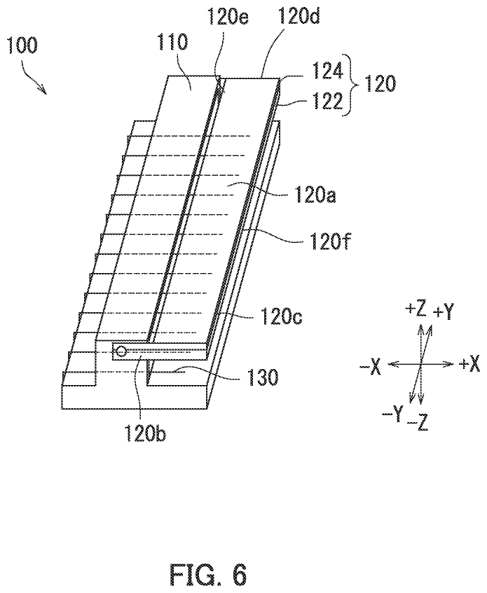

The following describes an electric connector 100 according to a fourth embodiment with reference to FIGS. 9 to 10C. FIG. 9 is a schematic perspective view of the electric connector 100 according to the fourth embodiment. The electric connector 100 illustrated in FIG. 9 has a configuration similar to that of the electric connector 100 illustrated in FIGS. 1 to 8 except that a housing 110 is provided with a ground terminal 140 in addition to signal terminals 130. As such, duplicate description is omitted for the purpose of avoiding redundant description.

The housing 110 is provided with the ground terminal 140 in addition to the signal terminals 130. The ground terminal is maintained at the ground potential. For example, the ground terminal 140 may be formed as a type of a contact terminal that is in contact with one of wires 210 (FIGS. 4A to 5 and 8) of a signal transmission member 200 likewise to the signal terminals 130.

Note that the ground terminal 140 may be maintained at the ground potential through a ground wire on a substrate 300 (FIGS. 5 and 8). Alternatively, the ground terminal 140 may be maintained at the ground potential through a ground wire that is one type of the wires 210 of the signal transmission member 200 (FIGS. 4A to 5 and 8).

The following describes a process of coupling the signal transmission member 200 to the electric connector 100 with reference to FIGS. 10A to 10C FIGS. 10A to 10C are schematic perspective views explaining the process of coupling the signal transmission member 200 to the electric connector 100 according to the fourth embodiment.

As illustrated in FIG. 10A, the electric connector 100 is prepared. Here, an upper surface 120a of the actuator 120 exhibits conductivity. Also, the actuator 120 of the electric connector 100 is positioned at the second position P2. The upper surface 120a of the actuator 120 is in contact with the signal terminals 130 and the ground terminal 140. Potentials of the signal terminals 130 and the ground terminal 140 are accordingly equal to one another through the upper surface 120a of the actuator 120. For example, when the ground terminal 140 is maintained at the ground potential through the ground wire on the substrate 300 (FIGS. 5 and 8), each of the upper surface 120a of the actuator 120, the signal terminals 130, and the ground terminal 140 is maintained at the ground potential.

The signal transmission member 200 is also prepared separately from the electric connector 100. The signal transmission member 200 includes wires 210 and a holding section 220. The wires 210 transmit electric signals. The holding section 220 holds the wires 210. The holding section 220 is formed from an insulating member.

As illustrated in FIG. 10B, the signal transmission member 200 is inserted into the electric connector 100. When the signal transmission member 200 is inserted into the electric connector 100, the wires 210 of the signal transmission member 200 are each electrically connected to a corresponding one of the ground terminal 140 and the signal terminals 130 of the electric connector 100. Preferably, the actuator 120 is positioned at the second position P2 at this time.

For example, even if the ground terminal 140 is not maintained at the ground potential through the ground wire on the substrate 300 (FIGS. 5 and 8), each of the upper surface 120a of the actuator 120, the signal terminals 130, and the ground terminal 140 can be maintained at the ground potential as long as one of the wires 210 of the signal transmission member 200 (FIGS. 4A to 5 and 8) is a ground wire maintained at the ground potential. Even if the signal transmission member 200 is charged, charge of the signal transmission member 200 can be dispersed as a result of the actuator 120 at the second position P2 being in contact with the signal terminals 130 and the ground terminal 140, thereby achieving inhibition of occurrence of a fault due to electrostatic discharge.

As illustrated in FIG. 10C, the actuator 120 moves from the second position P2 to the first position P1. As a result of movement of the actuator 120, the signal transmission member 200 is coupled to the electric connector 100.

Embodiments of the present invention have been described so far with reference to the drawings (FIGS. 1 to 10C). However, the present invention is not limited to the above embodiments, and can be practiced in various ways as embodiments within scope not departing from the essence of the present invention. Also, various inventions can be formed by appropriately combining elements of configuration disclosed in the above embodiments. For example, some of elements of configurations may be omitted from all of the elements of configuration indicated in the embodiments. The drawings schematically illustrate main elements of configuration in order to facilitate understanding, and the numbers and the like of elements of configuration illustrated in the drawings may differ from actual ones thereof in order to facilitate preparation of the drawings. Furthermore, each element of configuration indicated in the above embodiments is an example that does not impose any particular limitation, and various alterations thereof are possible within the scope not substantially departing from effects of the present invention.

Note that at least part of the actuator 120 exhibits conductivity in the above description with reference to FIGS. 1 to 10C, which should not be taken to limit the present invention. Any area of the actuator 120 may not have so-called conductivity.

The actuator 120 illustrated in FIGS. 1 to 10C is rectangular parallelepiped in shape extending in the longitudinal direction thereof and has a plurality of side surfaces 120b to 120e in addition to the upper surface 120a and the bottom surface 120f, which should not be taken to limit the present invention. The actuator 120 may be columnar in shape with elliptical upper and bottom surfaces. The actuator 120 may have one side surface in addition to an upper surface and a bottom surface. Alternatively, the number of side surfaces of the actuator 120 may not be limited to one or four and may be any number.

In the above description with reference to FIGS. 2A, 2B, 4A to 5, 8, and 10A to 10C, the pivotable range of the actuator 120 is 200 degrees or larger and 270 degrees or smaller, which should not be taken to limit the present invention. The pivotable range of the actuator 120 may be any value. However, the pivotable range of the actuator 120 is preferably greater than 180 degrees and no greater than 340 degrees.

Furthermore, the actuator 120 illustrated in FIGS. 2A, 2B, 4A to 5, 8, and 10A to 10C pivots relative to the housing 110, which should not be taken to limit the present invention. The actuator 120 may move in any manner relative to the housing 110. For example, the actuator 120 may slide on the housing 110 to move from the first position P1 to the second position P2.

For example, the actuator 120 may be mounted on the housing 110 in a slidable manner. In this case, as a result of the actuator 120 being positioned at the first position P1, the signal transmission member 200 is fixed with the wires of the signal transmission member 200 connected to the signal terminals 130. When the actuator 120 slides to move from the first position P1 to the second position P2, the bottom surface 120f of the actuator 120 comes in contact with the signal terminals 130. In this case, the bottom surface 120f of the actuator 120 serves as the contact surface.

Moreover, the actuator 120 of the electric connector 100 is positioned at the second position P2 in insertion of the signal transmission member 200 into the electric connector 100 in FIGS. 4B and 10B, which should not be taken to limit the present invention. The actuator 120 of the electric connector 100 may be positioned at any position other than the second position P2 in insertion of the signal transmission member 200 into the electric connector 100. For example, even through the actuator 120 of the electric connector 100 positioned at the second position P2 only before the signal transmission member 200 is inserted into the electric connector 100, charge of the signal terminals 130 can be dispersed and occurrence of a fault due to electrostatic discharge can be accordingly inhibited.

### INDUSTRIAL APPLICABILITY

The present invention is useful in the field of electric connectors.

### REFERENCE SINGS LIST

100 electric connector
110 housing
120 actuator
130 signal terminal

1. An electric connector to which a signal transmission member is to be coupled, the electric connector comprising:
a housing;
an actuator mounted on the housing; and
a signal terminal provided on the housing and electrically connected to a wire of the signal transmission member, wherein
when the actuator is positioned at a first position, the actuator is out of contact with the signal terminal, the first position being a position where the signal transmission member is fixed with the wire of the signal transmission member connected to the signal terminal, and
when the actuator moves from the first position to a specific second position, the actuator comes in contact with the signal terminal, the second position being a position where fixation of the signal transmission member is released.

2. The electric connector according to claim 1, wherein
the actuator has a contact surface that is away from the signal terminal when the actuator is positioned at the first position and at least part of which is in contact with the signal terminal when the actuator is positioned at the second position.

3. The electric connector according to claim 2, wherein
the contact surface of the actuator is conductive.

4. The electric connector according to claim 2, wherein
the contact surface of the actuator is maintained at a ground potential.

5. The electric connector according to claim 2, further comprising
a conductive member disposed on an outer side of the housing and electrically connected to the contact surface of the actuator.

6. The electric connector according to claim 2, wherein
the signal terminal is provided on a terminal placement surface of the housing,
the actuator has an upper surface that serves as the contact surface and a bottom surface that faces the terminal placement surface when the actuator is positioned at the first position,
the actuator is pivotable about an axis of rotation as a center relative to the housing, and
a pivotable range of the actuator from the first position to the second position about the axis of rotation as a center is 200 degrees or larger and 270 degrees or smaller.

7. The electric connector according to claim 6, wherein
the housing includes:
a base body with a plate shape of which an upper surface serves as the terminal placement surface;
a first side portion extending upward on one side of the base body in a first direction from the upper surface of the base body;
a second side portion extending upward on another side of the base body in the first direction from the upper surface of the base body; and
an upper portion located above the base body and connecting the first side portion to the second side portion,
the signal terminal extends in a second direction on the upper surface of the base body, the second direction being perpendicular to the first direction,
the axis of rotation of the actuator passes through each of the first side portion and the second side portion, and
the actuator is located on one side relative to the upper portion in the second direction when positioned at the first position, and located on another side relative to the upper portion in the second direction when positioned at the second position.

8. The electric connector according to claim 7, wherein
the signal terminal extends on the upper surface of the base body to an end of the base body on the another side in the second direction and extends along a side surface of the base body from the end of the base body on the another side, and
when positioned at the second position, the actuator is in contact with part of the signal terminal that is located on the end of the base body on the another side.

9. The electric connector according to claim 1, further comprising
a ground terminal provided on the housing, wherein
when the actuator moves from the first position to the second position, the actuator comes in contact with the signal terminal and the ground terminal.
